(19) United States
(12) Patent Application Publication
(10) Pub. No.: US 2026/0101042 A1
(43) Pub. Date: Apr. 9, 2026

(54) PROGRESSIVE FACE VIDEO COMPRESSION FRAMEWORK WITH ADAPTIVE VISUAL TOKENS

(71) Applicant: Alibaba (China) Co., Ltd., Hangzhou (CN)

(72) Inventors: Bolin CHEN, Kowloon Tong (HK); Yan YE, San Diego, CA (US); Jie CHEN, Beijing (CN); Ru-ling LIAO, Sunnyvale, CA (US)

(21) Appl. No.: 19/325,131

(22) Filed: Sep. 10, 2025

Related U.S. Application Data
(60) Provisional application No. 63/705,036, filed on Oct. 9, 2024.

(51) Int. Cl. H04N 19/139; H04N 19/172

(52) U.S. Cl. CPC H04N 19/139; H04N 19/172

(57) ABSTRACT

A video encoding method includes: receiving a video sequence including a first key frame and one or more inter frames following the first key frame; generating a reconstructed key frame corresponding to the first key frame; transforming the reconstructed key frame and the one or more inter frames to visual tokens with different granularities; and encoding one or more token bitstreams including coded information for one or more of the visual tokens selected based on a data transmission bandwidth.

### CROSS-REFERENCE TO RELATED APPLICATIONS

This application claims priority to U.S. Provisional Application No. 63/705,036, titled “PROGRESSIVE FACE VIDEO COMPRESSION FRAMEWORK WITH ADAPTIVE VISUAL TOKENS,” filed on Oct. 9, 2024, which is hereby incorporated by reference in its entirety.

### TECHNICAL FIELD

The present disclosure generally relates to video processing, and more particularly, to methods and apparatuses for a progressive face video compression framework with adaptive visual tokens.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards gets higher and higher.

### SUMMARY

According to some embodiments, a video encoding method includes: receiving a video sequence including a first key frame and one or more inter frames following the first key frame; generating a reconstructed key frame corresponding to the first key frame; transforming the reconstructed key frame and the one or more inter frames to visual tokens with different granularities; and encoding one or more token bitstreams including coded information for one or more of the visual tokens selected based on a data transmission bandwidth.

According to some embodiments, a video decoding method includes: receiving an image bitstream and one or more token bitstreams associated with a video sequence; decoding the image bitstream to obtain a reconstructed key frame; decoding the one or more token bitstreams to obtain one or more visual tokens, in which a size of the one or more visual tokens being coded is selected based on a data transmission bandwidth; and reconstructing the video sequence based on the one or more visual tokens and the reconstructed key frame.

According to some embodiments, a method of storing one or more bitstreams includes: generating one or more token bitstreams by: receiving a video sequence including a first key frame and one or more inter frames following the first key frame; generating a reconstructed key frame corresponding to the first key frame; transforming the reconstructed key frame and the one or more inter frames to visual tokens with different granularities; and encoding one or more token bitstreams including coded information for one or more of the visual tokens selected based on a data transmission bandwidth; and storing the one or more token bitstreams in a non-transitory computer-readable medium.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an example progressive face video coding (PFVC) framework, according to some embodiments of the present disclosure.

FIG. 2 is a block diagram of an example apparatus for encoding or decoding image data, according to some embodiments of the present disclosure.

FIG. 3 illustrates a schematic diagram of an example framework for video compression in a video coding system, according to some embodiments of the present disclosure.

FIG. 4 is a schematic diagram illustrating an example architecture of an end-to-end Deep-based Video Compression (DVC) framework, according to some embodiments of the present disclosure.

FIG. 5 is a schematic diagram illustrating a basic framework of the deep-based video generative compression scheme based on First Order Motion Model (FOMM), according to some embodiments of the present disclosure.

FIG. 6 is a schematic diagram illustrating an encoder of a deep-based video generative compression scheme based on Compact Feature Temporal Evolution (CFTE), according to some embodiments of the present disclosure.

FIG. 7 is a schematic diagram illustrating a decoder of a deep-based video generative compression scheme based on Compact Feature Temporal Evolution (CFTE), according to some embodiments of the present disclosure.

FIG. 8 is a schematic diagram illustrating an example progressive face video coding (PFVC) framework, according to some embodiments of the present disclosure.

FIG. 9 is a flowchart for an example video encoding method, according to some embodiments of the present disclosure.

FIG. 10 is a flowchart for an example video decoding method, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Recent years have witnessed a paradigm shift in the compression of video data, from signal-level coding to generative representation powered by Artificial Intelligence Generated Content (AIGC) models. For example, face video coding is increasingly becoming important in various metaverse and real-time video applications. The face video coding follows the vein of Model-Based Coding (MBC), which has been devoted to improving face video compression efficiency by exploiting strong face priors. However, the performance was hindered by the sub-par face analysis and synthesis abilities. Motivated by the rapid development of deep learning technologies, especially for deep generative models, the MBC framework can now be optimized towards the realistic reconstruction with vivid texture. Specifically, learning-based face reenactment/animation models can provide reasonable solutions for Generative Face Video Compression (GFVC). Namely, the encoder side employs the analysis model to effectively characterize complex facial motions whilst the decoder side utilizes the synthesis model to reconstruct high-quality face video. More specifically, the pixel-level facial signal can be economically represented into compact representations, such as 2D landmarks, 2D keypoints, 3D keypoints, temporal trajectory feature, segmentation map, and facial semantics, aligning with the mild assumption that the representation of visual information follows certain curvatures for human visual system. Consequently, it is possible to accomplish face video communications in the ultra-low bitrate scenarios.

Although the GFVC techniques can achieve promising compression performance, further improvement is describable to achieve higher compression efficiency and better generative image quality, as well as make them applicable to more practical applications. Moreover, there are still some drawbacks and challenges associated with the GFVC techniques, limiting their usage. In general, generative models focus on generating visually rich textures with given features, while video compression aims to reconstruct a given video with the allocated bitrate. That is, while generative models prioritize the quality of the generated content, compression techniques prioritize efficient representation and reconstruction of the original video by utilizing the available bitrate. Therefore, in the context of learning-based compression, the inference process inherently incorporates the ground-truth video content in encoding. This provides substantial room for designing generative techniques specifically tailored for compression.

Lossy video compression aims at achieving the minimal transmission bitrate (R) with the lowest possible distortion (D). Generally speaking, video compression can be viewed as a rate-distortion optimization regarding how to minimize the overall cost J_{cost} with a trade-off coefficient between R and D as follows:

$${J}_{cost} = D + λ R , \qquad ( 1 )$$

where λ is the Lagrange multiplier representing the R-D relationship for a particular quality level. According to the information theory, when more bits are cost to represent and transmit the data, the distortion incurred from the compressed representation is less perceivable. However, this theory is not fully suitable for the generative compression algorithms relying on the straightforward application of generation models, such that superior R-D trade-offs cannot be achieved in an overall bitrate coverage. Some of the GFVC's drawbacks are limited bitrate coverage and unstable reconstruction quality.

Regarding limited bitrate coverage, the coding overhead of generative compression algorithms is a cost for providing the key-reference frames with vivid texture/color and describing complex temporal motion with compact representations. In particular, the adjustment of the bitrate range is mainly determined by the compression level and dynamic number of the key-reference frame, while it is almost not affected by these compact representations. This is largely due to the fact that although these generative compression algorithms based on compact representations have bridged the gap between generation and compression tasks with distinct goals and trade-offs, the current mechanism designs typically force these algorithms to operate at a particular rate point.

Regarding unstable reconstruction quality, although generative models have powerful inference capabilities, their robustness in complex motion and long-term dependency scenes cannot be guaranteed, and is prone to produce unsatisfied image quality with annoying artifacts, missing details, and temporal inconsistencies. Moreover, once the R-D balance goal of the compression task becomes a constraint for the generation task, the powerful generation ability will be greatly restricted, which is like a tiger being trapped in a cage. As such, it is difficult to achieve stable visual reconstruction with precise motions and vivid textures from compact feature representations.

These above challenges and opportunities in generative compression, including R-D optimization, bitrate coverage, and model robustness, call for bridging generative models and effective compression with bandwidth intelligence, such that the face video communication can achieve bandwidth intelligence while offering high quality.

In some embodiments of the present disclosure, solutions are provided to solve the one or more of the above-identified problems and challenges associated with GFVC. Consistent with the disclosed embodiments, a Progressive Face Video Compression (PFVC) framework based on adaptive visual tokens can be used to facilitate generative face video communication towards bandwidth intelligence and robust reconstruction.

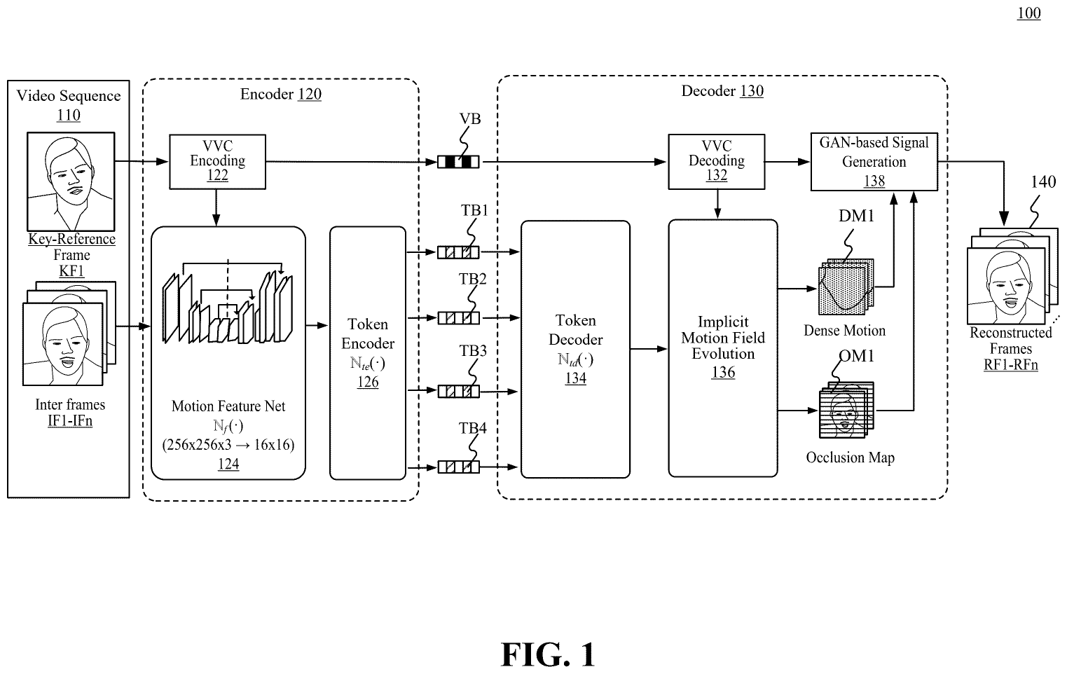

FIG. 1 is a schematic diagram illustrating an example progressive face video coding (PFVC) system 100, according to some embodiments of the present disclosure. As shown in FIG. 1, the PFVC system 100 is configured to process a video sequence 110 having a key frame KF1 and one or more inter frames IF1-IFn following the key frame KF1. The PFVC system 100 includes an encoder 120 and a decoder 130. In some embodiments, the encoder 120 includes an encoding module 122, a motion feature network 124, and a token encoder 126, and is configured to receive the video sequence 110 having the key frame KF1 and the one or more inter frames IF1-IFn.

In some embodiments, the encoding module 122 may be configured to use VVC codec to encode and output an image bitstream VB including coded information for the key frame KF1 of the video sequence. In addition, a reconstructed key frame corresponding to original key frame KF1 can also be obtained in the encoder 120. In particular, the key frame KF1 is reconstructed at the encoder side, in order to be matched with the reconstruction process later performed at the decoder side. The motion feature network 124 is configured to transform the obtained reconstructed key frame and the one or more inter frames IF1-IFn to visual tokens with different granularities. The token encoder 126 is configured to encode one or more token bitstreams TB1-TB4 including coded information for one or more of the visual tokens selected based on a data transmission bandwidth, e.g., a bandwidth of video streaming service or a bandwidth of a communication network used for transmitting video content. The image bitstream VB and the one or more token bitstreams TB1-TB4 can be sent to the decoder 130 for performing the decoding process.

In some embodiments, the decoder 130 includes a decoding module 132, a token decoder 134, an implicit motion field evolution module 136, and a generator 138 using Generative Adversarial Networks (GAN), and is configured to receive and process the image bitstream VB and the one or more token bitstreams TB1-TB4.

In some embodiments, the decoding module 132 may be configured to use VVC codec to decode the image bitstream VB to obtain a reconstructed key frame. The token decoder 134 is configured to decode the one or more token bitstreams TB1-TB4 to obtain one or more visual tokens. As explained above, the size of the one or more visual tokens being coded is selected based on a data transmission bandwidth.

The implicit motion field evolution module 136 is configured to receive the reconstructed key frame from the decoding module 132 and the visual token(s) from the token decoder 134 to output a dense motion field DM1 and an occlusion map OM1. Accordingly, the generator 138 can, based on the reconstructed key frame, the dense motion field DM1 and the occlusion map OM1, obtain the reconstruct frames RF1-RFn by using GAN-based signal reconstruction, and reconstruct the video sequence 140. In other words, the decoder 130 may reconstruct the video sequence 140 based on the one or more visual tokens and the reconstructed key frame by the implicit motion field evolution module 136 and the generator 138. Detailed operations and functions of the modules within the encoder 120 and the decoder 130 will be further discussed below.

By utilizing the visual tokenization technique for efficient signal synthesis, the proposed PFVC framework in FIG. 1 transforms complex visual face signal into visual motion tokens of different granularities in a progressive manner. As such, these visual tokens are capable of hierarchically estimating facial motions and reconstructing the corresponding face contents according to different bandwidth scenarios. Moreover, the proposed progressive token strategy allows the GFVC pipelines not to rely on compact representations for signal reconstruction, thus enhancing the effectiveness and robustness of the face generation process.

With the adaptive visual tokens, the proposed PFVC system 100 in FIG. 1 provides several benefits when compared to other GFVC algorithms. First, the proposed PFVC system 100 can characterize high-dimensional visual face signals into compact tokens with different granularities, ensuring greater feature adaptability in a learnable manner. In addition, different from the existing GFVC algorithms which can only control the R-D trade-offs by adjusting Quantization Parameter (QP) levels of the key-reference frame, the proposed PFVC system 100 in FIG. 1 can also achieve coding flexibility and bandwidth intelligence by transmitting visual tokens of different granularities. Furthermore, finer-granularity tokens can improve the face reconstruction robustness and stability, thereby solving the inaccurate motion estimation and unreliable generation problems that plague the existing GFVC pipelines due to compact representations. Further, the PFVC system 100 only needs one model to output visual features of different granularities and to achieve face reconstruction of different qualities instead of using multiple GFVC models, thereby greatly expanding the application possibilities.

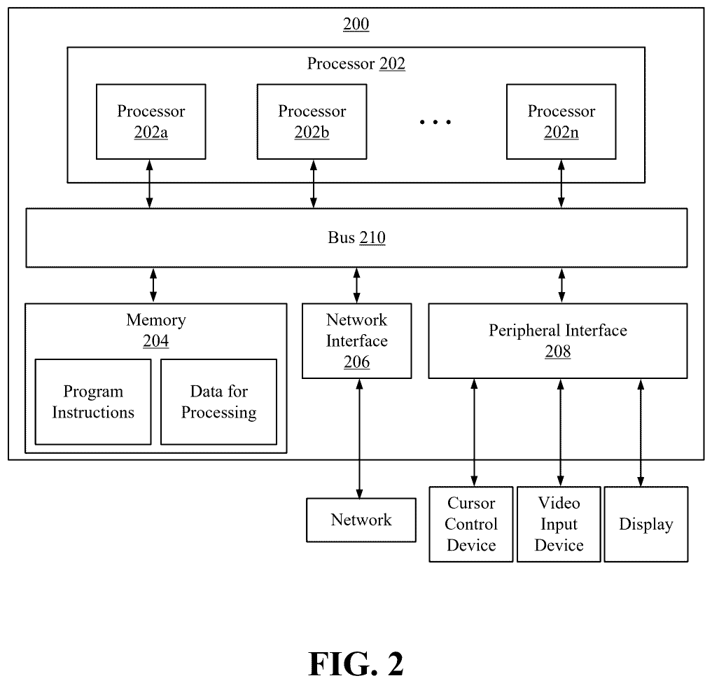

FIG. 2 is a block diagram of an example apparatus 200 for encoding or decoding image data, according to some embodiments of the present disclosure. As shown in FIG. 2, apparatus 200 can include processor 202. When processor 202 executes instructions described herein, apparatus 200 can become a specialized machine for video encoding or decoding. Processor 202 can be any type of circuitry capable of manipulating or processing information. For example, processor 202 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 202 can also be a set of processors grouped as a single logical component. For example, as shown in FIG. 2, processor 202 can include multiple processors, including processor 202a, processor 202b, and processor 202n.

Apparatus 200 can also include memory 204 configured to store data (e.g., a set of instructions, computer codes, intermediate data, or the like). For example, as shown in FIG. 2, the stored data can include program instructions (e.g., program instructions for implementing the stages in processes in the encoder 120 or the decoder 130 in FIG. 1) and data for processing (e.g., video sequence, video bitstream, or video stream). Processor 202 can access the program instructions and data for processing (e.g., via bus 210), and execute the program instructions to perform an operation or manipulation on the data for processing. Memory 204 can include a high-speed random-access storage device or a non-volatile storage device. In some embodiments, memory 204 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 204 can also be a group of memories (not shown in FIG. 2) grouped as a single logical component.

Bus 210 can be a communication device that transfers data between components inside apparatus 200, such as an internal bus (e.g., a CPU-memory bus), an external bus (e.g., a universal serial bus port, a peripheral component interconnect express port), or the like.

For ease of explanation without causing ambiguity, processors 202a-202n and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 200.

Apparatus 200 can further include network interface 206 to provide wired or wireless communication with a network (e.g., the Internet, an intranet, a local area network, a mobile communications network, or the like). In some embodiments, network interface 206 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 200 can further include peripheral interface 208 to provide a connection to one or more peripheral devices. As shown in FIG. 2, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process in the encoder 120 or the decoder 130 in FIG. 1) can be implemented as any combination of any software or hardware modules in apparatus 200. For example, some or all stages of process in the encoder 120 or the decoder 130 in FIG. 1 can be implemented as one or more software modules of apparatus 200, such as program instructions that can be loaded into memory 204. For another example, some or all stages of process in the encoder 120 or the decoder 130 in FIG. 1 can be implemented as one or more hardware modules of apparatus 200, such as a specialized data processing circuit (e.g., an FPGA, an ASIC, an NPU, or the like).

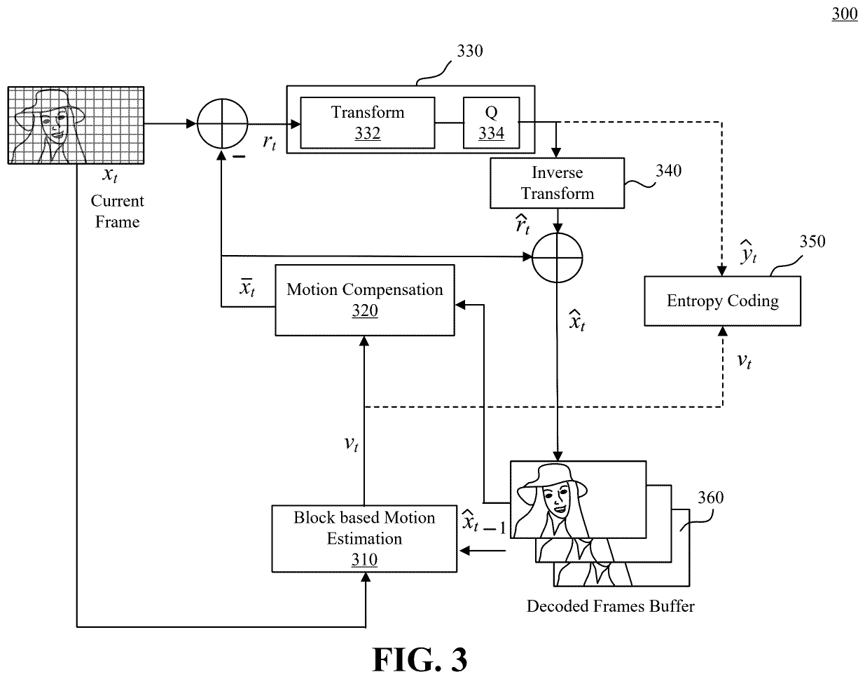

For better understanding of the PFVC framework proposed in various embodiments of the present disclosure, details of the architecture of various video compression framework, including end-to-end Deep-based Video Compression (DVC), Generative Face Video Compression (GFVC) based on First Order Motion Model (FOMM), and Deep-based video generative compression based on Compact Feature Temporal Evolution (CFTE) are discussed below in accompanying with FIGS. 3-7.

Video compression standards, such as AVC, HEVC, and VVC, have been developed to achieve compression performance. In these standards, a block-based hybrid video coding framework can be used to exploit the spatial redundancy, temporal redundancy and information entropy redundancy in the video.

FIG. 3 illustrates a schematic diagram of an example framework 300 for video compression in a video coding system, according to some embodiments of the present disclosure. Generally, the video compression encoder generates the bitstream based on the input current frames. And the decoder reconstructs the video frames based on the received bitstreams. The framework 300 in FIG. 3 follows the predict-transform architecture.

The input video is processed block by block. Specifically, the input frame xₜ is split into a set of blocks, e.g., square regions, of the same size (e.g., 8×8). The encoding procedure of the video compression algorithm in the encoder side will be discussed as follows.

The the input frame xₜ is processed by a block-based motion estimation module 310 configured to estimate the motion between the current frame xₜ and a previous reconstructed frame \hat{x}ₜ₋₁. Based on the the input frame xₜ and the previous reconstructed frame \hat{x}ₜ₋₁, the block-based motion estimation module 310 outputs a corresponding motion vector vₜ for each block. Then, the corresponding motion vector vₜ is processed by a motion compensation module 320 in order to obtain a predicted frame x̅ₜ by copying the corresponding pixels in the previous reconstructed frame \hat{x}ₜ₋₁, to the current frame based on the motion vector vₜ defined in the motion estimation module 310. Accordingly, a residual rₜ between the original frame xₜ and the predicted frame x̅ₜ is obtained as rₜ=xₜ−x̅ₜ. In some embodiments, the motion compensated prediction performed above is also known as an “inter prediction,” “inter-picture prediction,” or “temporal prediction.”

After the residual rₜ is generated, the encoder can feed the residual rₜ to a transform stage 332 and a quantization stage 334 in a transform and quantization module 330 to generate quantized result ŷₜ. In some embodiments, a linear transform (e.g., DCT) can be used before the quantization for better compression performance. Different transform algorithms can use different base patterns. Various transform algorithms can be used at transform stage 332, such as, for example, a discrete cosine transform, a discrete sine transform, or the like. The transform at transform stage 332 is invertible. That is, the encoder can restore the residual rₜ by an inverse operation of the transform (referred to as an “inverse transform”) performed by an inverse transform module 340. For a video coding standard, the encoder and a corresponding decoder can use the same transform algorithm (thus the same base patterns). Thus, the encoder can record only the transform coefficients, from which a decoder can reconstruct the residual rₜ without receiving the base patterns from the encoder.

The encoder can further compress the transform coefficients at quantization stage 334. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 334, the encoder can generate quantized residual coefficients ŷₜ by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized residual coefficients ŷₜ, by which the transform coefficients are further compressed. The quantization process is also invertible, in which quantized residual coefficients ŷₜ can be reconstructed to the transform coefficients in an inverse operation of the quantization (referred to as “inverse quantization”).

Because the encoder disregards the remainders of such divisions in the rounding operation, the quantization stage 334 can be lossy. Typically, quantization stage 334 can contribute the most information loss in the encoding process. The larger the information loss is, the fewer bits the quantized residual coefficients ŷₜ can need. For obtaining different levels of information loss, the encoder can use different values of the quantization parameter or any other parameter of the quantization process.

The encoder can feed the motion vector vₜ and quantized residual coefficients ŷₜ to a binary coding module 350 to generate the bitstream to complete a forward path. By the binary coding module 350, the encoder can encode the motion vector vₜ and quantized residual coefficients ŷₜ using a binary coding technique, such as, for example, entropy coding, variable length coding, arithmetic coding, Huffman coding, context-adaptive binary arithmetic coding (CABAC), or any other lossless or lossy compression algorithm. Accordingly, the motion vector vₜ and the quantized residual coefficients ŷₜ can be encoded into bits by an entropy coding method and sent to the decoder.

As explained above, by the inverse transform module 340, the quantized result ŷₜ can be used for obtaining the reconstructed residual ft by the inverse transform. During the process, after quantization stage 334, the encoder can feed quantized residual coefficients ŷₜ to an inverse quantization stage and an inverse transform stage in the inverse transform module 340 to generate reconstructed residual \hat{r}ₜ. At the inverse quantization stage, the encoder can perform inverse quantization on quantized residual coefficients ŷₜ to generate reconstructed transform coefficients. At the inverse transform stage, the encoder can generate the reconstructed residual \hat{r}ₜ based on the reconstructed transform coefficients. Then, the encoder can add the reconstructed residual \hat{r}ₜ to the predicted frame x̅ₜ to obtain the reconstructed frame \hat{x}ₜ to be used for the next iteration of process, i.e., \hat{x}ₜ=\hat{r}ₜ+x̅ₜ. The reconstructed frame xₜ will be used by the (t+1)ₜₕ frame in the motion estimation module 310 for the motion estimation.

After generating the reconstructed frame \hat{x}ₜ, the encoder can apply a loop filter to the reconstructed frame \hat{x}ₜ to reduce or eliminate distortion (e.g., blocking artifacts) introduced by the inter prediction. In some embodiments, the encoder can apply various loop filter techniques at the loop filter stage, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in a decoded frames buffer 360 for later use (e.g., to be used as an inter-prediction reference frame for a future frame of the video sequence). The encoder can store one or more reference frames in the buffer 360 to be used for inter prediction. In some embodiments, the encoder can encode parameters of the loop filter (e.g., a loop filter strength) at the coding stage, along with the motion vector vₜ and quantized residual coefficients ŷₜ, and other information. The encoder can perform the process discussed above iteratively to encode each frame of the video sequence.

For the decoder, based on the bits provided by the binary coding module 350 in the encoder, corresponding motion compensation, inverse transform, and frame reconstruction operations can be performed to obtain the reconstructed frame \hat{x}ₜ.

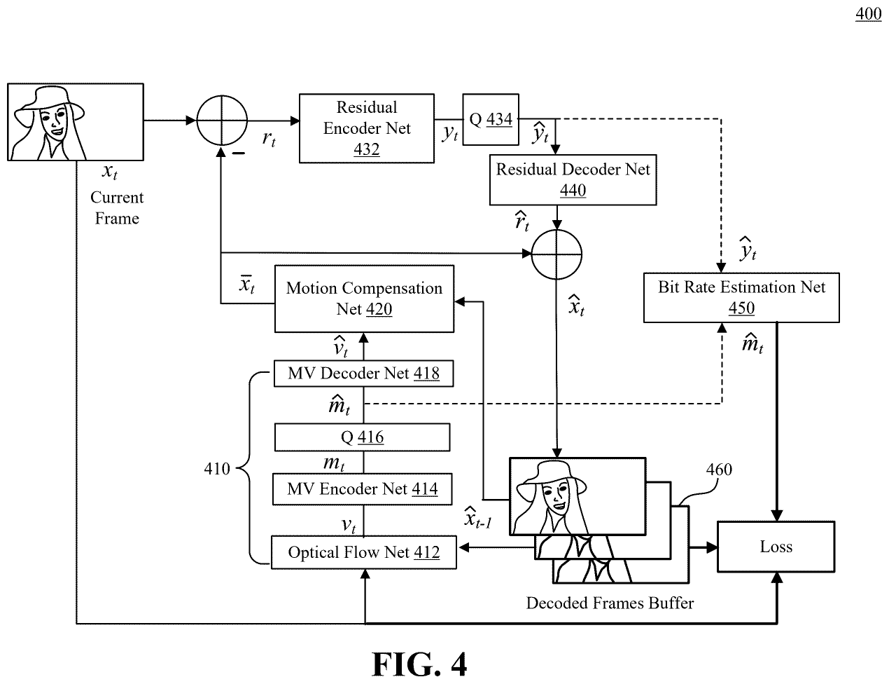

Next, end-to-end Deep-based Video Compression (DVC) techniques are described. FIG. 4 is a schematic diagram illustrating an example architecture of an end-to-end Deep-based Video Compression (DVC) framework 400, according to some embodiments of the present disclosure.

With the development of deep learning, numerous deep-learning-based algorithms can be introduced to replace or enhance video coding tools, including intra/inter prediction, entropy coding and in-loop filtering.

The video compression framework 400 shown in FIG. 4 employs an end-to-end video compression deep model that can jointly optimize some or all components for the video compression, such as motion estimation, motion compression, and residual compression. Specifically, a learning-based optical flow estimation can be utilized to obtain the motion information and reconstruct the current frames. Then two auto-encoder style neural networks are employed to compress the corresponding motion and residual information. The modules can be jointly learned through a single loss function, in which the modules collaborate with each other by considering the trade-off between reducing the number of compression bits and improving the quality of the decoded video. There is one-to-one correspondence between the video compression framework 300 shown in FIG. 3 and the end-to-end deep-based video compression framework 400 shown in FIG. 4, and the relationship and differences between the two frameworks 300 and 400 will be discussed below.

In the framework 400, a motion estimation and compression module 410 includes an optical flow network 412, a motion vector (MV) encoder network 414, a quantization module 416, and a motion vector (MV) decoder network 418. The optical flow network 412 can be a convolutional neural network (CNN) model configured to estimate the optical flow, which is considered as motion information vₜ. Instead of directly encoding the raw optical flow values, the MV encoder network 414 and the MV decoder network 418 are respectively configured to compress and decode the optical flow values, in which the motion representation outputted by the MV encoder network 414 is denoted as mₜ, and a quantized motion representation outputted by the quantization module 416 is denoted as \hat{m}ₜ. Then the corresponding reconstructed motion information \hat{v}ₜ can be decoded by using the MV decoder network 418 according to the quantized motion representation \hat{m}ₜ.

For the motion compensation process, a motion compensation network 420 is designed to obtain the predicted frame x̅ₜ based on the reconstructed motion information \hat{v}ₜ.

For the transform and quantization process, the linear transform in the video compression framework 300 in FIG. 3 is replaced by a highly non-linear residual encoder-decoder network, and the residual rₜ is non-linearly mapped to the representation yₜ by a residual encoder network 432. Then, the output yₜ is quantized by a quantization module 434 to obtain the quantized representation ŷₜ. In some embodiments, in order to build an end-to-end training scheme, a quantization method can be used. Then, the quantized representation ŷₜ is fed into a residual decoder network 440 to obtain the reconstructed residual \hat{r}ₜ.

During the entropy coding stage, at a testing stage, the quantized motion representation \hat{m}ₜ and the residual representation ŷₜ are coded into bits by a bit rate estimation network 450 and sent to the decoder. At a training stage, to estimate the number of bits cost, the CNNs can be used to obtain the probability distribution of each symbol in \hat{m}ₜ and ŷₜ.

The frame reconstruction process and the buffer 460 used in the frame reconstruction process in the framework 400 in FIG. 4 is the same as the frame reconstruction process and the buffer 360 in the framework 300 in FIG. 3, and thus detailed discussions are omitted herein for the sake of brevity.

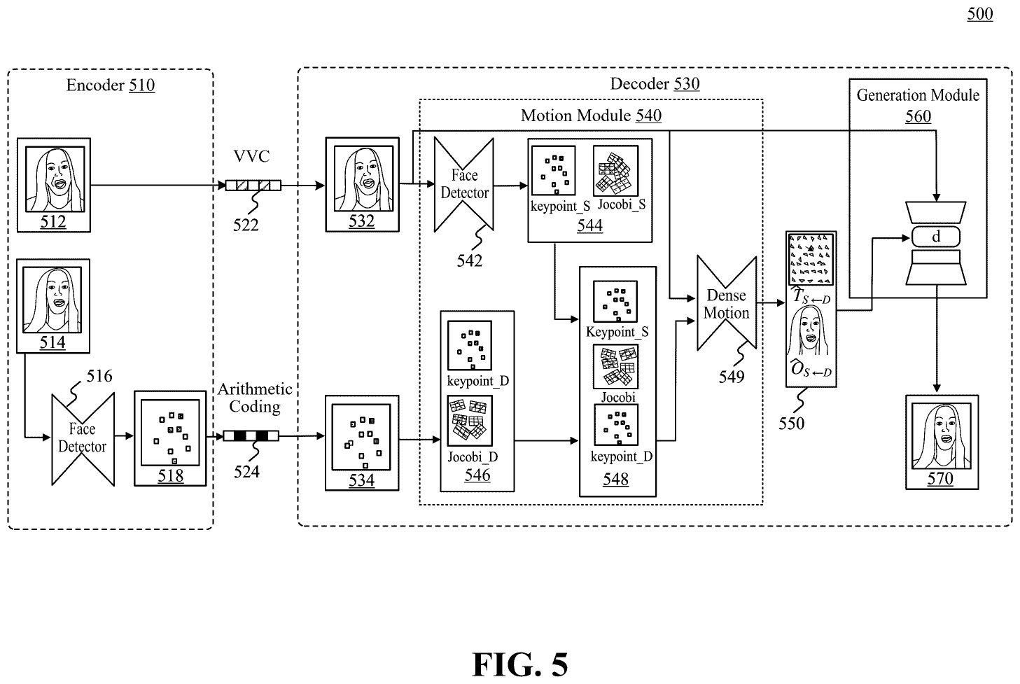

Next, generative video coding consistent with embodiments of the present disclosure will be described. FIG. 5 is a schematic diagram illustrating a basic framework 500 of the deep-based video generative compression scheme based on First Order Motion Model (FOMM), according to some embodiments of the present disclosure.

With the emergence of deep generative models including Variational Auto-Encoding (VAE) and Generative Adversarial Networks (GAN), the facial video compression can achieve promising performance improvement. While various algorithms can realize frame reconstruction with a few facial parameters through the powerful rendering ability of deep generative models, some head posture movements and facial expression movements still fail to be accurately rendered compared with the original moving video.

In the embodiments of FIG. 5, the FOMM deforms a reference source frame to follow the motion of a driving video. This method works on various types of videos and can be used in the face animation application. FOMM follows an encoder-decoder architecture with a motion transfer component.

As shown in FIG. 5, in the framework 500, the encoder 510 is configured to encode a source frame 512 via an image/video compression method, such as HEVC/VVC or JPEG/BPG. In some embodiments, the VVC is used to compress the source frame 512 to obtain a bitstream 522.

As shown in FIG. 5, in the framework 500, the encoder 510 is configured to use a keypoint decoder (e.g., a face detector) 516 to extract motion representation 518 for a driving frame 514, which can be coded by arithmetic coding to obtain a bitstream 524. The decoder 530 is configured to decode the bitstreams 522 and 524 to obtain the reconstructed source frame 532 and the reconstructed motion representation 534. Then, in the motion module 540 in the decoder 530, a keypoint decoder (e.g., a face detector) 542 is configured to process the reconstructed source frame 532 to obtain source frame keypoints information 544. Similarly, the reconstructed motion representation 534 can be used to obtain driving frame keypoints information 546. By combining the source frame keypoints information 544 and the driving frame keypoints information 546, keypoints and local affine transformations 548, including each keypoint and the Jacobians computed in each keypoint location can be obtained. Then, a dense motion network 549 is configured to obtain and output a dense motion field and an occlusion map 550, according to the keypoints and local affine transformations 548.

For example, a keypoint extractor is learned using an equivariant loss, without explicit labels. By this keypoint extractor, two sets of ten learned keypoints are computed for the source and driving frames. The learned keypoints is transformed from the feature map with the size of channel×64×64 via the Gaussian map function, thus every corresponding keypoint can represent different channels' feature information. In the above description, every keypoint is point of (x, y) that can represent the most important information of feature map.

As another example, the dense motion network 549 can use the landmarks and the reconstructed source frame 532 to produce the dense motion field and the occlusion map 550.

Finally, the generation module 560 is configured to output an image 570 of the object. For example, the generation module 560 may include a generator network configured to warp the resulting feature map using the dense motion field by using a differentiable grid-sample operation, and then multiply the warped map with the occlusion map. As another example, in the FOMM encoder-decoder architecture in FIG. 5, the decoder 530 is configured to generate an image 570 from the warped map.

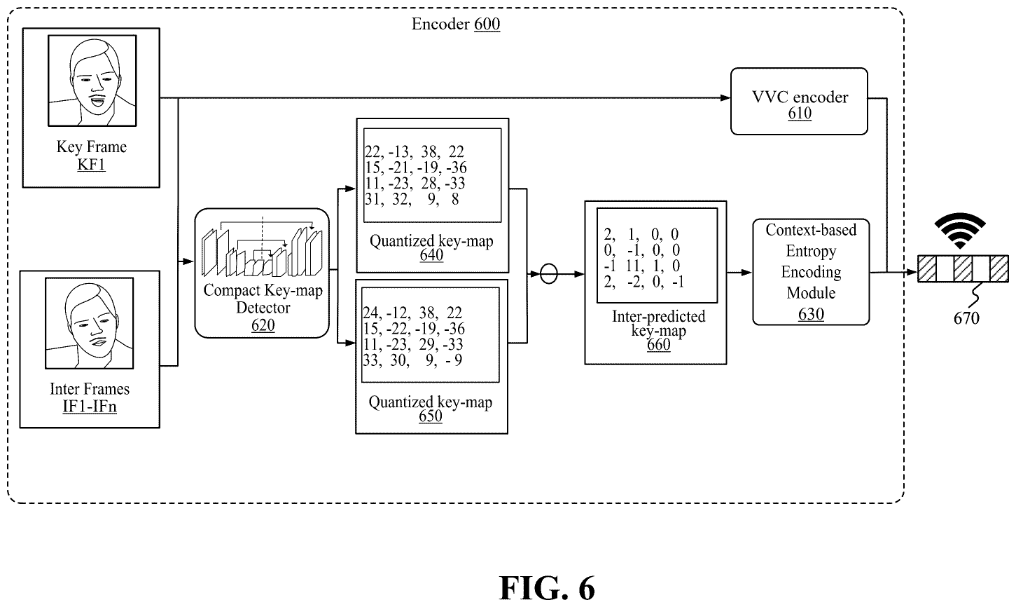

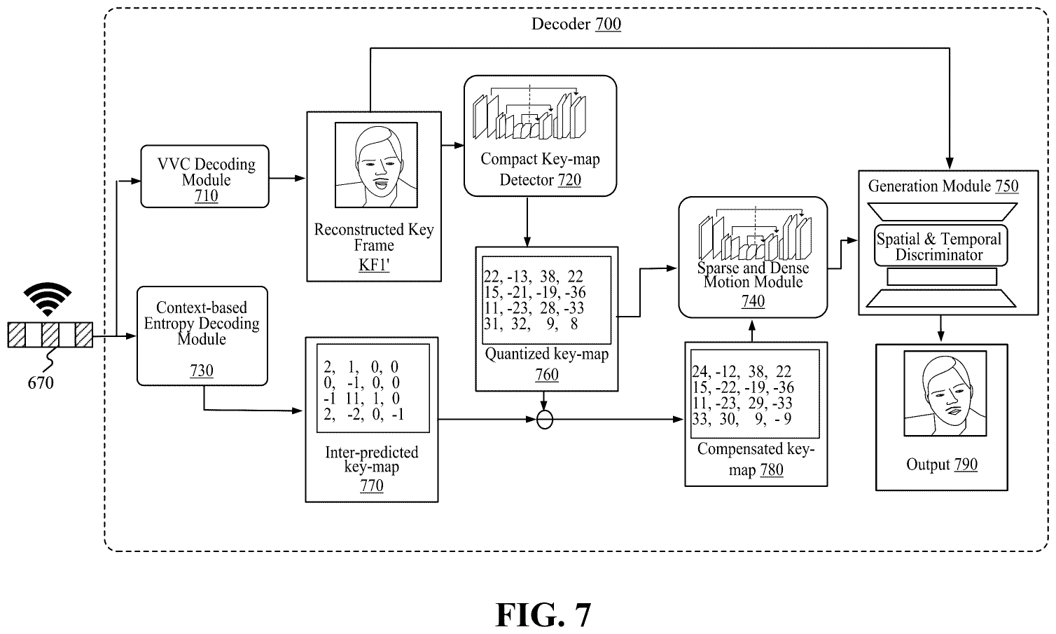

FIG. 6 is a schematic diagram illustrating an encoder 600 of a deep-based video generative compression scheme based on Compact Feature Temporal Evolution (CFTE), according to some embodiments of the present disclosure. FIG. 7 is a schematic diagram illustrating a decoder 700 of a deep-based video generative compression scheme based on Compact Feature Temporal Evolution (CFTE), according to some embodiments of the present disclosure. The framework in FIGS. 6-7 follows an encoder-decoder architecture.

As shown in FIG. 6, at the encoder side, the encoder 600 of the compression framework includes an VVC encoder 610, a feature extractor 620, which can be a compact key-map detector, and a feature coding module 630, which can be a Context-based Entropy Encoding module. The VVC encoder 610 is configured to compress the key frame KF1. The feature extractor 620 is configured to extract the compact human features of the key frame KF1 and the other inter frames IF1-IFn. The feature coding module 630 is configured to compress the inter-predicted residuals of compact human features. First, the key frame KF1 representing the human textures is compressed with the VVC encoder 610. Through the compact feature extractor 620, the key frame KF1 can be represented with a compact feature matrix 640 (e.g., a quantized key-map) with the size of 1×4×4, and each of the subsequent inter frames IF1-IFn can be represented with a compact feature matrix 650 (e.g., a quantized key-map) with the size of 1×4×4. In some embodiments, the size of compact feature matrices 640 and 650 is not fixed and the number of feature parameters can also be increased or decreased according to the specific requirement of bit consumption. Then, these extracted features are inter-predicted and quantized into a residual matrix 660 (e.g., an inter-predicted key-map). Then, the feature coding module 630 is configured to entropy-code the residuals into the bitstream 670.

Moreover, as shown in FIG. 7, at the decoder 700, the compression framework includes an VVC decoder 710, a feature extractor 620, which can be a compact key-map detector, a feature decoding module 730, which can be a Context-based Entropy Decoding module, a sparce and dense motion module 740, and a generation module 750.

The VVC decoder 710 is configured to obtain the reconstructed key frame KF1′ based on the received bitstream 670. The feature extractor 720 is configured to extract the compact human features of the reconstructed key frame KF1′, to obtain the reconstructed compact feature matrix 760 (e.g., a quantized key-map) with the size of 1×4×4. Accordingly, during the generation of the video, the decoded key frame KF1′ from the bitstream 670 can be further represented in the form of features through compact feature extraction. The feature decoding module 730 is configured to output the reconstructed residual matrix 770 (e.g., an inter-predicted key-map) including reconstructed inter-predicted residuals of compact human features. Accordingly, in the reconstruction of the compact features, a reconstructed compact feature matrix 780 (e.g., a compensated key-map) with the size of 1×4×4 for each of the inter frames IF1-IFn can be obtained by entropy decoding and compensation. Subsequently, given the features from the key and inter frames, the sparce and dense motion module 740 is configured to calculate the relevant sparse motion field and facilitate the generation of the pixel-wise dense motion map and occlusion map. Finally, the generation module 750 is configured to, based on the deep generative model, use the decoded key frame, pixel-wise dense motion map and occlusion map with implicit motion field characterization, to produce the final video 790 with accurate appearance, pose, and expression. Accordingly, the final video 790 can be generated by leveraging the reconstructed features and decoded key frame.

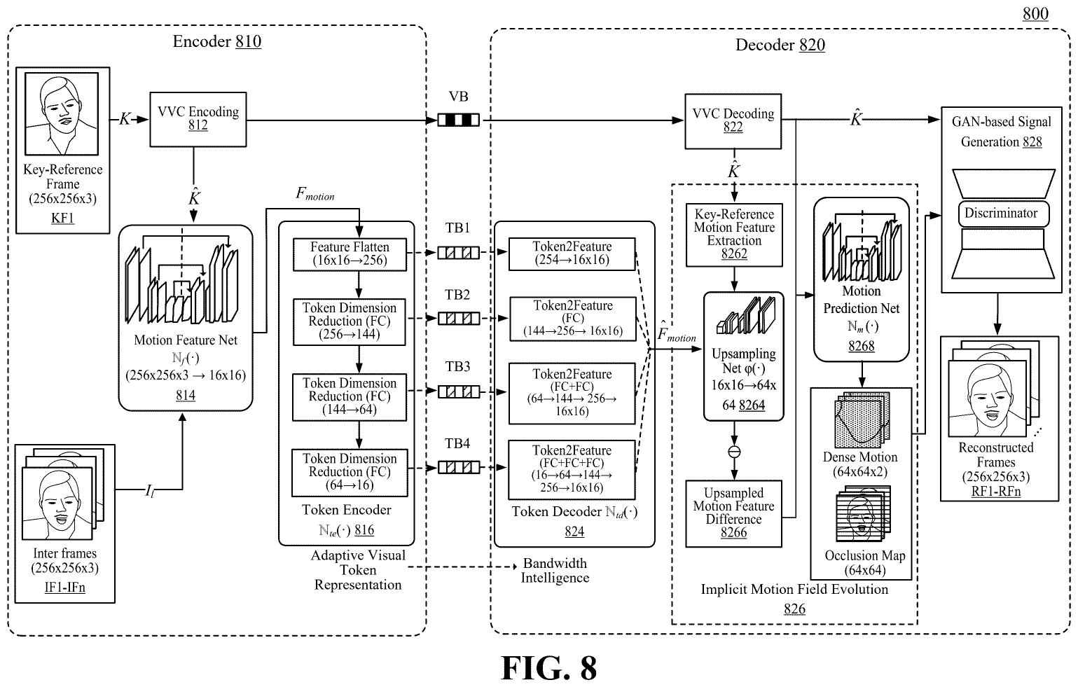

FIG. 8 is a schematic diagram illustrating another example PFVC framework 800 for bandwidth-intelligent face video communication, according to some embodiments of the present disclosure. As shown in FIG. 8, the PFVC framework 800 is grounded on the adaptive visual tokens and thus capable of exploring exceptional capabilities in the trade-offs between reconstruction robustness and bandwidth intelligence.

Similar to the embodiments shown in FIG. 1, the PFVC system 800 is configured to process a video sequence having a key frame KF1 and one or more inter frames IF1-IFn following the key frame KF1. The PFVC system 800 includes an encoder 810 and a decoder 820. In some embodiments, the encoder 810 includes an encoding module 812, a motion feature network 814, and a token encoder 816, and is configured to receive the key frame KF1 and the one or more inter frames IF1-IFn.

As discussed above, at the encoder side, the input video signal can be classified as the key frame KF1, which is also referred to as a key-reference frame K (e.g., the first frame of this video), and subsequent inter frames IF1-IFn, which is also referred to as inter frames Iₗ (1≤l≤n, l∈Z). The key-reference frame K can be intra-coded by the encoding module 812, e.g., an off-the-shelf VVC encoder, to provide a rich texture reference for the subsequent frame reconstruction. The encoding module 812 is also configured to encode the image bitstream VB including coded information for the key frame KF1. That is, the image bitstream VB is decodable to reconstruct the key frame KF1.

In some embodiments, the reconstructed (e.g., VVC-reconstructed) key-reference frame \hat{K} and remaining inter frames Iₗ are characterized into a series of adaptive visual tokens in a progressive manner. For example, the motion feature network 814 may be configured to extract motion features from the reconstructed key frame KF1 and the one or more inter frames IF1-IFn. The token encoder 816 may be configured to transform the motion features into the visual tokens with different granularities.

As shown in FIG. 8, the motion feature network 814 may extract the motion features by down-sampling the reconstructed key frame and the one or more inter frames by a scale factor to obtain down-sampled frames, and processing the down-sampled frames using a convolutional neural network (CNN) to obtain the motion features. In some embodiments, the motion features outputted by the motion feature network 814 can be two-dimensional (e.g., 16×16).

After receiving the two-dimensional motion features, the token encoder 816 may first perform feature flattening and convert the motion features to a first one-dimensional token with a first size (e.g., 256), and then sample the first one-dimensional token to obtain a second one-dimensional token with a second size (e.g., 144) smaller than the first size. As shown in FIG. 8, in some embodiments, the token encoder 816 may sequentially obtain the visual tokens with different sizes using a series of fully-connected (FC) layers. For example, the visual tokens may include one-dimensional tokens with respective sizes of 256, 144, 64, and 16.

Then, the bandwidth scenario determines which granularity (or granularities) of the visual tokens can be compressed. Subsequently, the determined tokens can be coded using inter prediction, quantization, and entropy coding to output one or more token bitstreams TB1-TB4, where a context-adaptive arithmetic codec can be employed to achieve optimal compression performance. Accordingly, the one or more token bitstreams TB1-TB4 include coded information for one or more of the visual tokens selected based on the data transmission bandwidth.

The image bitstream VB and the one or more token bitstreams TB1-TB4 are transmitted to the decoder 820. At the decoder side of the PFVC framework 800, the decoded adaptive visual tokens are used to reconstruct face video at different quality levels. Similar to the decoder 130 in FIG. 1, the decoder 820 includes a decoding module 822, a token decoder 824, an implicit motion field evolution module 826, and a generator 828 using GAN, and is configured to receive and process the image bitstream VB and the one or more token bitstreams TB1-TB4.

In particular, the decoding module 822, e.g., an off-the-shelf VVC decoder, can be employed to reconstruct the key-reference frame.

In addition, by the token decoder 824, the adaptive tokens of inter frames can be obtained by context-based entropy decoding and difference compensation. These decoded visual tokens are sent to the implicit motion field evolution module 826, developed to infer the temporal motion evolution and transformed into pixel-wise dense motion fields, where their motion quality can be gradually improved with better token granularity. Further, in the generator 828 using GAN, the powerful generative model can be used to reconstruct the face video with the guidance of the decoded key-reference frames and these inferred dense motion fields, to output the reconstructed frames RF1-RFn.

As shown in FIG. 8, in some embodiments, adaptive sparse token representation can be used in the PFVC framework 800. The high-dimensional visual signal \hat{K} or Iₗ can be transformed to adaptive sparse tokens with different granularities via a token extractor. In particular, the face frames first undergo a down-sampling operation φ(·) through scale factors. The down-sampled face frames are then fed into the motion feature network [symbol] _{f}(·) that is mainly composed of a U-Net architecture and a series of convolution/normalization operations, to obtain motion features Fₘₒₜᵢₒₙ with the size of 1×16×16. The motion features entailing accurate head posture and facial expressions can be learned in an unsupervised manner, according to equation (2):

$${F}_{motion} = {ℕ}_{f} ( ϕ ( X , s ) ) , \qquad ( 2 )$$

where X represents the reconstructed key-reference frame \hat{K} or the inter frames Iₗ.

Afterwards, the learned motion features are fed into a token network [symbol] ₜ(·) that is essentially an encoder-decoder translator with three Fully-Connected (FC) layers. At the encoder part [symbol] ₜₑ(·) of this token network in the token encoder 816, the 2-D motion features are first flatten into a 1-D tokens with the dimension of 256, and then are sequentially sampled into three other 1-D tokens via FC layers with the dimensions of, e.g., 144, 64 and 16. It is noted that the number of the FC layers and the specific dimension of each FC layer described above are merely examples and not meant to limit the present disclosure, and the number of the FC layers and the specific dimension of each FC layer can be set according to actual needs. The produced adaptive token list Lₜₒₖₑₙₛ is denoted as:

$${L}_{tokens} = {ℕ}_{te} ( {F}_{motion} ) , \qquad ( 3 )$$

where the dimensions of adaptive tokens Lₜₒₖₑₙₛ can be, for example, 256, 144, 64 and 16. In other words, depending on the given bandwidth environment, visual tokens of different granularities can be further coded into token bitstreams TB1-TB4 and actualize variable bitrate. After the tokens \hat{L}ₜₒₖₑₙₛ are decoded, they are input into the decoder part [symbol] _{td}(·) of the token network in the token decoder 824 for the corresponding reconstruction of motion features \hat{F}ₘₒₜᵢₒₙ:

$${\hat{F}}_{motion} = {ℕ}_{td} ( {L}_{tokens} ) . \qquad ( 4 )$$

Overall, the proposed token network in FIG. 8 can realize feature sparsity and produce visual tokens of different granularities, thus providing great possibilities to explore compression scalability.

In some embodiments, implicit motion field evolution can be used by the disclosed PFVC framework 800. Given the decoded key-reference frame \hat{K}, the extracted motion features

$${F}_{motion}^{\hat{K}}$$

from \hat{K} and the decoded motion features

$${\hat{F}}_{motion}^{{I}_{l}}$$

from Iₗ, an implicit motion field evolution scheme can be designed to achieve effective motion transformations from features to pixel-wise fields. Different from Compact Feature for Temporal Evolution (CFTE) and Compact Temporal Trajectory Representation (CTTR) using the sparse-to-dense motion estimation strategy to generate a coarse deformed frame and then transform this frame for motion fields, the proposed scheme in the PFVC framework 800 can directly use finer-granularity feature to infer motion fields via neural network learning.

For example, the implicit motion field evolution module 826 may include a motion feature extraction unit 8262, an up-sampled learning network 8264, an upsampled motion feature difference unit 8266, and a motion prediction network 8268. The motion feature extraction unit 8262 is configured to obtain the extracted motion features

$${F}_{motion}^{\hat{K}}$$

from the decoded key-reference frame \hat{K}. Then, the up-sampled learning network 8264 provides an up-sampled learning network φ(·) can be employed to perform scale transformation for

$${F}_{motion}^{\hat{K}}$$

and

$${F}_{motion}^{{I}_{l}} .$$

Accordingly, the upsampled motion feature difference unit 8266 can be configured to calculate the difference between these scaled features according to equation (5):

$${Diff}_{〈 {I}_{l} , K 〉} = φ ( {\hat{F}}_{motion}^{{I}_{l}} ) - φ ( {F}_{motion}^{\hat{K}} ) . \qquad ( 5 )$$

As an implicit motion change information, Diff_{<I}_{ₗ}_{,\hat{K}>} can be treated as the input together with the down-sampled \hat{K} into the motion prediction network 8268, [symbol] ₘ(·), aiming at estimating pixel-wise dense motion map

$${M}_{d e n s e}^{{I}_{l}}$$

and occlusion map

$${M}_{o c c l u s i o n}^{{I}_{l}}$$

for face signal reconstruction. The process performed by the motion prediction network 8268 can be formulated as the following equations (6) and (7):

$${M}_{dense}^{{I}_{l}} = {P}_{1} ( {ℕ}_{m} ( concat ( \hat{K} , {Diff}_{〈 {I}_{l} , \hat{K} 〉} ) ) ) ; \qquad ( 6 )$$

$${M}_{occlusion}^{{I}_{l}} = {P}_{2} ( {ℕ}_{m} ( concat ( \hat{K} , {Diff}_{〈 {I}_{l} , \hat{K} 〉} ) ) ) \qquad ( 7 )$$

where P₁(·) and P₂(·) represent two different predicted operation.

In some embodiments, GAN-based signal reconstruction is used by the disclosed PFVC framework 800. Analogous to the GFVC generator designs, in the generator 828, a flow-warped GAN module [symbol] _{GAN}(·) can be adopted to reconstruct realistic face signal Îₗ in order to output the reconstructed frames RF1-RFn for the inter frames IF1-IFn. In particular, the generator 828 may be configured to first warp the key-reference frame \hat{K} with the dense motion map

$${M}_{d e n s e}^{{I}_{l}}$$

for motion guidance and then the transformed features are further marked with the occlusion map

$${M}_{o c c l u s i o n}^{{I}_{l}}$$

for occlusion impainting, according to equation (8):

$${\hat{I}}_{l} = {ℕ}_{GAN} ( {M}_{occlusion}^{{I}_{l}} ⊙ {f}_{w} ( \hat{K} , {M}_{dense}^{{I}_{l}} ) ) , \qquad ( 8 )$$

where f_{w} and ⊙ describe the back-warping and the Hadamard product operations.

In some embodiments, to make the proposed PFVC compatible with different token granularities and achieve high-quality motion transformations within the same model, a progressive model training strategy with the granular probability guidance can be used to desired optimization objective. In particular, assuming that the PFVC model needs to be trained for N epochs and can process M granularities G={G₁, G₂, . . . , G_{M}}, the overall model training is divided into

$$S = \{ {S}_{1} , {S}_{2} , … , {S}_{\frac{M}{N + 1}} \} , {S}_{\frac{M}{N + 1}}$$

∈Z stages. In each stage, the PFVC model is instructed how to learn different token granularities with the given probabilistic ratios P={P₁, P₂, . . . , P_{M}}. It is understood that in each stage, the given probabilistic ratios for all granularities should be summed to 1. More importantly, to prevent the overall model capacity from being directly reduced by the coarse-grained tokens, the proposed progressive strategy prioritizes training of fine granularity in the early training stages and progressively introduces coarse-grained tokens in the subsequent stages. Besides, during the

$${S}_{1} ∼ {S}_{\frac{M - N - 1}{N + 1}}$$

stages, the maximum probability can be assigned to the corresponding newly-introduced token granularity to improve the PFVC model's acceptance of this granularity. As for the

$${S}_{\frac{M}{N + 1}}$$

stage, the probability of each granularity can be set at the same ratio for stabilizing model training.

In some embodiments, in addition to the proposed progressive training strategy, the perceptual loss, adversarial loss and feature matching loss can be adopted to supervise all PFVC stages in an end-to-end manner.

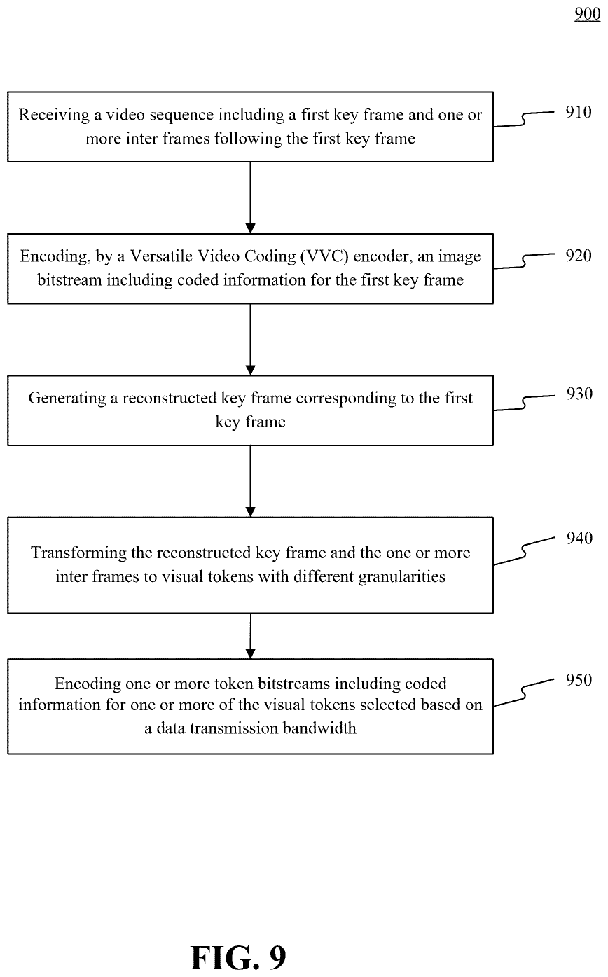

FIG. 9 is a flowchart for an example video encoding method 900, according to some embodiments of the present disclosure. The video encoding method 900 can be performed by an encoder to encode a video bitstream. For example, the encoder can be implemented as one or more software or hardware components of an apparatus (e.g., apparatus 200 in FIG. 2) for encoding the bitstream (e.g., image bitstream VB and token bitstreams TB1-TB4 in FIG. 8) for reconstructing a video frame or a video sequence. For example, a processor (e.g., processor 202 in FIG. 2) can perform the method 900. As shown in FIG. 9, the method 900 includes the following steps 910-950.

At step 910, the encoder receives a video sequence having a first key frame (e.g., key frame KF1 in FIG. 8) and one or more inter frames (e.g., inter frames IF1-IFn in FIG. 8) following the first key frame, and classifies the first key frame and the one or more inter frames.

At step 920, the encoder may code the first key frame using a Versatile Video Coding (VVC) encoder. In some embodiments, the encoder may encode an image bitstream (e.g., image bitstream VB in FIG. 8) including coded information for the first key frame by the VVC encoder, in which the image bitstream is decodable to reconstruct the first key frame.

At step 930, the encoder may generate a reconstructed key frame corresponding to the first key frame. For example, the encoder may code, by a Versatile Video Coding (VVC) encoder, the first key frame to generate coded information for the first key frame, and generate the reconstructed key frame based on the coded information. At step 940, the encoder may transform the reconstructed key frame and the one or more inter frames to visual tokens with different granularities. In some embodiments, the encoder may sequentially obtain the visual tokens with different sizes using a series of fully-connected (FC) layers. The visual tokens may include one-dimensional tokens with respective sizes of 256, 144, 64, and 16.

In some embodiments, the encoder may extract motion features from the reconstructed key frame and the one or more inter frames, and transform the motion features into the visual tokens with different granularities. For example, the encoder may down-sample the reconstructed key frame and the one or more inter frames by a scale factor to obtain down-sampled frames, and process the down-sampled frames using a convolutional neural network to obtain the extracted motion features. In some embodiments, the motion features may be two-dimensional. After obtaining the extracted motion features, the encoder may transform the motion features to the visual tokens by first converting the motion features to a first one-dimensional token with a first size, and then sampling the first one-dimensional token to obtain a second one-dimensional token with a second size smaller than the first size.

At step 950, the encoder may encode one or more token bitstreams (e.g., token bitstreams TB1-TB4 in FIG. 8) including coded information for one or more of the visual tokens selected based on a data transmission bandwidth.

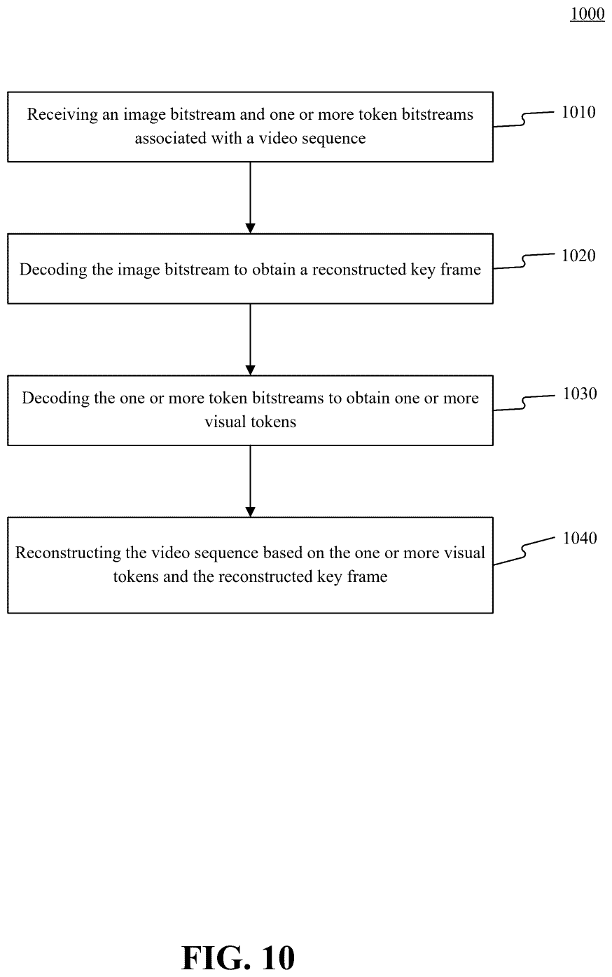

FIG. 10 is a flowchart for an example video decoding method 1000 for decoding a bitstream, according to some embodiments of the present disclosure. The video decoding method 1000 can be performed by a decoder to decode a video bitstream. For example, the decoder can be implemented as one or more software or hardware components of an apparatus (e.g., apparatus 200 in FIG. 2) for decoding the bitstream (e.g., image bitstream VB and token bitstreams TB1-TB4 in FIG. 8) to reconstruct a video frame or a video sequence. For example, a processor (e.g., processor 202 in FIG. 2) can perform the video decoding method 1000. As shown in FIG. 10, the video decoding method 1000 includes the following steps 1010-1040.

At step 1010, the decoder receives an image bitstream (e.g., image bitstream VB in FIG. 8) and one or more token bitstreams (e.g., token bitstream TB1-TB4 in FIG. 8) associated with a video sequence having a first key frame and one or more inter frames following the first key frame.

In steps 1020-1040, after receiving the bitstreams, the decoder may decode the bitstreams to output a video sequence. At step 1020, after receiving the bitstreams, the decoder may decode the image bitstream to reconstruct a key frame of the video sequence and obtain a reconstructed key frame.

At step 1030, after receiving the bitstreams, the decoder may decode the one or more token bitstreams to obtain one or more visual tokens. The size of the one or more visual tokens being coded is selected based on a data transmission bandwidth. In some embodiments, the one or more token bitstreams are decodable to obtain one or more one-dimensional visual tokens with a size of 256, 144, 64, or 16.

At step 1040, the decoder may reconstruct the video sequence based on the one or more visual tokens and the reconstructed key frame. Specifically, in some embodiments, the decoder may further extract the reconstructed key frame to obtain motion features of the reconstructed key frame for reconstructing the video sequence, and transform the one or more visual tokens into motion features of the one or more inter frames for reconstructing the video sequence. In some embodiments, the one or more visual tokens are one-dimensional. The decoder may convert the one or more visual tokens into one or more two-dimensional motion features. For example, the decoder may apply one or more fully-connected (FC) layers, in response to the size of the one or more visual tokens.

In some embodiments, at step 1040, the decoder may reconstruct the video sequence by generating motion information (e.g., dense motion map

$${M}_{d e n s e}^{{I}_{l}} )$$

and occlusion information (e.g., occlusion map

$${M}_{occlusion}^{{I}_{l}} )$$

based on the motion features of the reconstructed key frame and the motion features of the one or more inter frames, and reconstructing the one or more inter frames based on the motion information, the occlusion information, and the reconstructed key frame. As explained above in the embodiments of FIG. 8, the motion information and occlusion information can be obtained by up-sampling the motion features, calculating a difference between the motion features of the inter frame(s) and the motion features of the reconstructed key frame to obtain motion change information (e.g., Diff_{<I}_{ₗ}_{,\hat{K}>)}), and processing the reconstructed key frame and the motion change information using a motion prediction network (e.g., motion prediction network 8268 in FIG. 8) to obtain the motion information and the occlusion information.

By the above video encoding method 900 and video decoding method 1000, the PFVC framework proposed in various embodiments of the present disclosure can progressively characterize high-dimensional visual face signal into adaptive sparse tokens and actualize different-quality face signal reconstruction. As such, the disclosed PFVC scheme enjoys the advantages of coding flexibility, bandwidth intelligence, and reliable reconstruction for face video communication. In addition, the PFVC framework can employ a feature representation mechanism. An adaptive visual tokenization mechanism can be used to describe facial motions at different granularities, such that the coded bitstream can be featured with different visual tokens in a progressive manner. Moreover, these adaptive visual tokens can be further transformed into pixel-wise dense motion fields for the temporal evolution inference via the implicit motion learning and GAN-based frame generation schemes.

In some embodiments, the PFVC framework can employ a progressive model training strategy. For example, a progressive training strategy can be used for generative video coding model, where different-granularities visual tokens are progressively introduced in each training stage and also guided with probability learning. Therefore, instead of using multiple models, the PFVC needs only one model to be compatible with overall bandwidth coverage.

In some embodiments, a non-transitory computer-readable storage medium storing an image bitstream and one or more token bitstreams is also provided. The image bitstream and the token bitstream(s) can be encoded and decoded by the video encoding methods and the video decoding methods according to various embodiments of the present disclosure.

As explained above, an image bitstream and token bitstream(s) can be generated based on a video sequence. The image bitstream includes coded information for reconstructing a key frame of the video sequence and obtaining extracted features of the reconstructed key frame, and the token bitstream(s) include coded information for one or more of the visual tokens selected based on a data transmission bandwidth. Accordingly, the image bitstream and the token bitstream(s) can be generated based on an input video sequence, and stored in a non-transitory computer-readable storage medium.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:
1. A video encoding method, comprising:
receiving a video sequence comprising a first key frame and one or more inter frames following the first key frame;
generating a reconstructed key frame corresponding to the first key frame;
transforming the reconstructed key frame and the one or more inter frames to a plurality of visual tokens with different granularities; and
encoding one or more token bitstreams comprising coded information for one or more of the plurality of visual tokens selected based on a data transmission bandwidth.
2. The video encoding method of clause 1, further comprising:
extracting motion features from the reconstructed key frame and the one or more inter frames; and
transforming the motion features into the plurality of visual tokens with different granularities.
3. The video encoding method of clause 2, wherein the motion features are two-dimensional, and transforming the motion features to the plurality of visual tokens comprises:
converting the motion features to a first one-dimensional token with a first size; and
sampling the first one-dimensional token to obtain a second one-dimensional token with a second size smaller than the first size.
4. The video encoding method of clause 2 or 3, wherein extracting the motion features from the reconstructed key frame and the one or more inter frames comprises:
down-sampling the reconstructed key frame and the one or more inter frames by a scale factor to obtain down-sampled frames; and
processing the down-sampled frames using a convolutional neural network to obtain the motion features.
5. The video encoding method of any of clauses 1-4, wherein transforming the reconstructed key frame and the one or more inter frames to the plurality of visual tokens comprises:
sequentially obtaining the plurality of visual tokens with different sizes using a series of fully-connected (FC) layers.
6. The video encoding method of any of clauses 1-5, wherein the plurality of visual tokens comprise one-dimensional tokens with respective sizes of 256, 144, 64, and 16.
7. The video encoding method of any of clauses 1-6, further comprising:
encoding, by a Versatile Video Coding (VVC) encoder, an image bitstream comprising coded information for the first key frame, wherein the image bitstream is decodable to reconstruct the first key frame.
8. The video encoding method of any of clauses 1-7, wherein generating the reconstructed key frame corresponding to the first key frame comprises:
coding, by a Versatile Video Coding (VVC) encoder, the first key frame to generate coded information for the first key frame; and
generating the reconstructed key frame based on the coded information.
9. A video decoding method, comprising:
receiving an image bitstream and one or more token bitstreams associated with a video sequence;
decoding the image bitstream to obtain a reconstructed key frame;
decoding the one or more token bitstreams to obtain one or more visual tokens, wherein a size of the one or more visual tokens being coded is selected based on a data transmission bandwidth; and
reconstructing the video sequence based on the one or more visual tokens and the reconstructed key frame.
10. The video decoding method of clause 9, wherein reconstructing the video sequence based on the one or more visual tokens and the reconstructed key frame comprises:
extracting the reconstructed key frame to obtain motion features of the reconstructed key frame; and
transforming the one or more visual tokens into motion features of one or more inter frames following the reconstructed key frame.
11. The video decoding method of clause 10, wherein the one or more visual tokens are one-dimensional, and the video decoding method further comprises:
converting the one or more visual tokens into one or more two-dimensional motion features.
12. The video decoding method of clause 11, wherein converting the one or more visual tokens into the one or more two-dimensional motion features comprises:
applying one or more fully-connected (FC) layers, in response to the size of the one or more visual tokens.
13. The video decoding method of any of clauses 10-12, further comprising:
generating motion information and occlusion information based on the motion features of the reconstructed key frame and the motion features of the one or more inter frames; and
reconstructing the one or more inter frames based on the motion information, the occlusion information, and the reconstructed key frame.
14. The video decoding method of clause 13, wherein obtaining the motion information and occlusion information comprises:
up-sampling the motion features;
calculating a difference between the motion features of the one or more inter frames and the motion features of the reconstructed key frame to obtain motion change information; and
processing the reconstructed key frame and the motion change information using a motion prediction network to obtain the motion information and the occlusion information.
15. The video decoding method of any of clauses 9-14, wherein the one or more token bitstreams are decodable to obtain one or more one-dimensional visual tokens with a size of 256, 144, 64, or 16.
16. A method of storing one or more bitstreams, the method comprising:
generating one or more token bitstreams by:
receiving a video sequence comprising a first key frame and one or more inter frames following the first key frame;
generating a reconstructed key frame corresponding to the first key frame;
transforming the reconstructed key frame and the one or more inter frames to a plurality of visual tokens with different granularities; and
encoding one or more token bitstreams comprising coded information for one or more of the plurality of visual tokens selected based on a data transmission bandwidth; and
storing the one or more token bitstreams in a non-transitory computer-readable medium.
17. The method according to clause 16, wherein generating the one or more token bitstreams further comprises:
extracting motion features from the reconstructed key frame and the one or more inter frames; and
transforming the motion features into the plurality of visual tokens with different granularities.
18. The method according to clause 17, wherein the motion features are two-dimensional motion features, and transforming the motion features to the plurality of visual tokens comprises:
converting the motion features to a first one-dimensional token with a first size; and
sampling the first one-dimensional token to obtain a second one-dimensional token with a second size smaller than the first size.
19. The method according to clause 17 or 18, wherein extracting the motion features from the reconstructed key frame and the one or more inter frames comprises:
down-sampling the reconstructed key frame and the one or more inter frames by a scale factor to obtain down-sampled frames; and
processing the down-sampled frames using a convolutional neural network to obtain the motion features.
20. The method according to any of clauses 16-19, further comprising:
encoding, by a Versatile Video Coding (VVC) encoder, an image bitstream comprising coded information for the first key frame, wherein the image bitstream is decodable to reconstruct the first key frame; and
storing the image bitstream in the non-transitory computer-readable medium. It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments, and the embodiments described in the present disclosure can be freely combined. Accordingly, although specific terms are employed, they are used in a generic and descriptive sense only and not for purposes of limitation.

What is claimed is:

1. A video encoding method, comprising:
receiving a video sequence comprising a first key frame and one or more inter frames following the first key frame;
generating a reconstructed key frame corresponding to the first key frame;
transforming the reconstructed key frame and the one or more inter frames to a plurality of visual tokens with different granularities; and
encoding one or more token bitstreams comprising coded information for one or more of the plurality of visual tokens selected based on a data transmission bandwidth.

2. The video encoding method of claim 1, further comprising:
extracting motion features from the reconstructed key frame and the one or more inter frames; and
transforming the motion features into the plurality of visual tokens with different granularities.

3. The video encoding method of claim 2, wherein the motion features are two-dimensional, and transforming the motion features to the plurality of visual tokens comprises:
converting the motion features to a first one-dimensional token with a first size; and
sampling the first one-dimensional token to obtain a second one-dimensional token with a second size smaller than the first size.

4. The video encoding method of claim 2, wherein extracting the motion features from the reconstructed key frame and the one or more inter frames comprises:
down-sampling the reconstructed key frame and the one or more inter frames by a scale factor to obtain down-sampled frames; and
processing the down-sampled frames using a convolutional neural network to obtain the motion features.

5. The video encoding method of claim 1, wherein transforming the reconstructed key frame and the one or more inter frames to the plurality of visual tokens comprises:
sequentially obtaining the plurality of visual tokens with different sizes using a series of fully-connected (FC) layers.

6. The video encoding method of claim 1, wherein the plurality of visual tokens comprise one-dimensional tokens with respective sizes of 256, 144, 64, and 16.

7. The video encoding method of claim 1, further comprising:
encoding, by a Versatile Video Coding (VVC) encoder, an image bitstream comprising coded information for the first key frame, wherein the image bitstream is decodable to reconstruct the first key frame.

8. The video encoding method of claim 1, wherein generating the reconstructed key frame corresponding to the first key frame comprises:
coding, by a Versatile Video Coding (VVC) encoder, the first key frame to generate coded information for the first key frame; and
generating the reconstructed key frame based on the coded information.

9. A video decoding method, comprising:
receiving an image bitstream and one or more token bitstreams associated with a video sequence;
decoding the image bitstream to obtain a reconstructed key frame;
decoding the one or more token bitstreams to obtain one or more visual tokens, wherein a size of the one or more visual tokens being coded is selected based on a data transmission bandwidth; and
reconstructing the video sequence based on the one or more visual tokens and the reconstructed key frame.

10. The video decoding method of claim 9, wherein reconstructing the video sequence based on the one or more visual tokens and the reconstructed key frame comprises:
extracting the reconstructed key frame to obtain motion features of the reconstructed key frame; and
transforming the one or more visual tokens into motion features of one or more inter frames following the reconstructed key frame.

11. The video decoding method of claim 10, wherein the one or more visual tokens are one-dimensional, and the video decoding method further comprises:
converting the one or more visual tokens into one or more two-dimensional motion features.

12. The video decoding method of claim 11, wherein converting the one or more visual tokens into the one or more two-dimensional motion features comprises:
applying one or more fully-connected (FC) layers, in response to the size of the one or more visual tokens.

13. The video decoding method of claim 10, further comprising:
generating motion information and occlusion information based on the motion features of the reconstructed key frame and the motion features of the one or more inter frames; and
reconstructing the one or more inter frames based on the motion information, the occlusion information, and the reconstructed key frame.

14. The video decoding method of claim 13, wherein obtaining the motion information and occlusion information comprises:
up-sampling the motion features;
calculating a difference between the motion features of the one or more inter frames and the motion features of the reconstructed key frame to obtain motion change information; and
processing the reconstructed key frame and the motion change information using a motion prediction network to obtain the motion information and the occlusion information.

15. The video decoding method of claim 9, wherein the one or more token bitstreams are decodable to obtain one or more one-dimensional visual tokens with a size of 256, 144, 64, or 16.

16. A method of storing one or more bitstreams, the method comprising:
generating one or more token bitstreams by:
receiving a video sequence comprising a first key frame and one or more inter frames following the first key frame;
generating a reconstructed key frame corresponding to the first key frame;
transforming the reconstructed key frame and the one or more inter frames to a plurality of visual tokens with different granularities; and
encoding one or more token bitstreams comprising coded information for one or more of the plurality of visual tokens selected based on a data transmission bandwidth; and
storing the one or more token bitstreams in a non-transitory computer-readable medium.

17. The method according to claim 16, wherein generating the one or more token bitstreams further comprises:
extracting motion features from the reconstructed key frame and the one or more inter frames; and
transforming the motion features into the plurality of visual tokens with different granularities.

18. The method according to claim 17, wherein the motion features are two-dimensional motion features, and transforming the motion features to the plurality of visual tokens comprises:
converting the motion features to a first one-dimensional token with a first size; and
sampling the first one-dimensional token to obtain a second one-dimensional token with a second size smaller than the first size.

19. The method according to claim 17, wherein extracting the motion features from the reconstructed key frame and the one or more inter frames comprises:
down-sampling the reconstructed key frame and the one or more inter frames by a scale factor to obtain down-sampled frames; and
processing the down-sampled frames using a convolutional neural network to obtain the motion features.

20. The method according to claim 16, further comprising:
encoding, by a Versatile Video Coding (VVC) encoder, an image bitstream comprising coded information for the first key frame, wherein the image bitstream is decodable to reconstruct the first key frame; and
storing the image bitstream in the non-transitory computer-readable medium.
